(19) United States
(12) Patent Application Publication
(10) Pub. No.: US 2026/0218723 A1
(43) Pub. Date: Jul. 30, 2026

(54) A VOLUTE MODULE

(71) Applicant: GRUNDFOS HOLDING A/S, Bjerringbro (DK)

(72) Inventors: Troels JEPSEN, Bjerringbro (DK); Steen MIKKELSEN, Bjerringbro (DK); Per ADAMSEN, Bjerringbro (DK); Peter MØNSTER, Bjerringbro (DK)

(21) Appl. No.: 19/139,932

(22) PCT Filed: Dec. 18, 2023
(86) PCT No.: PCT/EP2023/086446

§ 371 Date: Jun. 17, 2025

(30) Foreign Application Priority Data
Jan. 6, 2023 (DK) PA 2023 70006

(51) Int. Cl. F04D 29/44; F04D 1/10

(52) U.S. Cl. CPC F04D 29/44; F04D 1/10

(57) ABSTRACT

A volute module for a single-stage centrifugal pump and a multi-stage centrifugal pump. The volute module has a body defining a volute surrounding an impeller chamber. The volute module further comprises an unencapsulated impeller in the impeller chamber. The volute module can be used as part of a multi-stage centrifugal pump by placing additional impeller housings in the impeller chamber. The last stage of the volute module is, however, always formed by the unencapsulated impeller whose flow is directed towards the volute and the same body can be used for single-stage and multi-stage centrifugal pumps. Further described and claimed are a single-stage centrifugal pump and a multi-stage centrifugal pump comprising the volute module.

### CROSS REFERENCE TO RELATED APPLICATIONS

This application is a United States National Phase Application of International Application PCT/EP2023/086446, filed Dec. 18, 2023, and claims the benefit of priority under 35 U.S.C. § 119 of Danish Application PA 2023 70006, filed Jan. 6, 2023, the entire contents of which are incorporated herein by reference.

### TECHNICAL FIELD

The present invention is directed to a volute module for a single-stage centrifugal pump and a multi-stage centrifugal pump. Further, the invention is directed to a single-stage centrifugal pump comprising a volute module as well as a multi-stage centrifugal pump comprising a volute module.

### BACKGROUND

In the prior art single-stage centrifugal pumps and multi-stage centrifugal pumps are generally well-known. In a single-stage centrifugal pump a single impeller is arranged rotatably in an impeller chamber. The impeller is driven by a drive means, for example, an electric motor and accelerates a pump fluid drawn through an inlet into the impeller chamber towards a pressure outlet. The dynamic energy of the rotating pump fluid is commonly converted into a static pressure at the pressure outlet with the help of a volute that surrounds the impeller chamber and channels the rotating flow towards the pressure outlet.

In order to increase the pump head, multi-stage centrifugal pumps comprise multiple stacked impellers. Each of the impellers is located inside a separate impeller housing. The pump fluid flows into the initial-stage impeller housing where the first or initial impeller is arranged. The impeller transfers the energy from the motor to the pump fluid. Guide vanes formed on the inside of the initial-stage impeller housing encapsulating the initial impeller convert the rotation of the pump fluid into pressure and guide the flow of the pump fluid towards the subsequent stage of the multi-stage centrifugal pump.

The subsequent pump stage is again formed by an impeller encapsulated in an impeller housing. The pump fluid provided by the initial pump stage is set into rotation by the impeller. The impeller housing of the subsequent impeller stage also comprises guide vanes which convert the rotation of the pump fluid into pressure and direct the flow of the pump fluid either to a further subsequent impeller stage or to a pressure outlet of the multi-stage centrifugal pump.

The many different requirements for single-stage centrifugal pumps and multi-stage centrifugal pumps have resulted in a huge number of different models for different purposes. In particular, specific pumps exist for many different pump heads and flow requirements. This large number of different pumps complicates the manufacturing of pumps and increases the cost of manufacturing due to the large number of different parts that are required and the many different tools that are required to create the parts.

### SUMMARY

In view of the above, it can be considered an object of the present invention to simplify pump production by reducing the number of parts required for providing single-stage centrifugal pumps and multi-stage centrifugal pumps.

The object is solved by a volute module, a single-stage centrifugal pump and a multi-stage centrifugal pump according to the disclosure. Preferred embodiments of the invention are the subject matter described.

In a first aspect the problem underlying the present invention is solved by a volute module for a single-stage centrifugal pump and a multi-stage centrifugal pump. The volute module comprises a body defining at least part of an impeller chamber as well as a volute at least partially surrounding the impeller chamber. The volute module further comprises an unencapsulated impeller rotatable about a drive axis in the impeller chamber. The volute module is configured such that a rotating flow of pump fluid created by the unencapsulated impeller is directed towards the volute which channels the rotating flow of pump fluid towards a pressure outlet of the volute module. The volute module further comprises an initial-stage impeller housing in the impeller chamber when the pump housing is used as part of a multi-stage centrifugal pump. The initial-stage impeller housing encapsulates an impeller rotatable about the drive axis and defines guide vanes directing a flow of a pump fluid from the impeller of the initial-stage impeller housing towards an impeller of a subsequent stage of the multi-stage impeller pump. The subsequent stage of the multi-stage impeller pump is formed by the unencapsulated impeller or by an intermediate-stage impeller housing which encapsulates an impeller rotatable about the drive axis and defines guide vanes.

In other words, the same volute module can be used both for a single-stage centrifugal pump and a multi-stage centrifugal pump. The volute module forms an impeller chamber which receives, depending on the configuration as a single-stage or a multi-stage pump, one or more impellers. The impeller chamber is at least partially formed by a body of the volute module which may form the lateral walls and a bottom wall of the impeller chamber. The body of the volute module which also defines the volute, and the pressure outlet may, for example, be formed as a single piece and can, for example, be made from cast iron, titanium, stainless steel, a plastic material, a composite material, or any other material suited for the application. The body of the volute could, for example, be manufactured using a traditional casting process, a 3D printing process, or any other process suitable for the part.

At least part of the lateral or outer walls of the impeller chamber may additionally be formed by a sleeve. Using a sleeve may, in particular, be helpful when the volute module is used as part of a multi-stage centrifugal pump.

In any case, one unencapsulated impeller is arranged in the impeller chamber of the volute module. This impeller is referred to as the unencapsulated impeller as it is not arranged inside or encapsulated by a further impeller housing that is placed inside the impeller chamber. Thus, the pump fluid set into rotation by the unencapsulated impeller is always directed towards an inner surface of an outer wall of the volute module and, thus, the volute which is formed at the perimeter of the impeller chamber.

In case the volute module is used as a single-stage centrifugal pump, some or all of the rotating flow created by the unencapsulated impeller may be directly accelerated from the unencapsulated impeller towards the volute. In particular, in case the volute module is used as part of a multi-stage centrifugal pump, the rotating flow may have to flow along an inner surface of the impeller chamber. The inner surface of the impeller chamber may be formed by a sleeve or by the body of the volute module in case the unencapsulated impeller is not aligned with the volute.

In any case, no guide vanes are provided in the volute module that would convert the rotating flow of the pump fluid created by the unencapsulated impeller into a linear flow before the flow hits and is subsequently channeled by the volute. In particular, no guide vanes are provided that would direct the flow of the unencapsulated impeller away from the bottom wall of the impeller chamber and/or towards a drive axis of the unencapsulated impeller. In all embodiments, the volute converts the rotating flow of pump fluid into a linear flow directed towards the pressure outlet of the volute module. Thus, regardless of whether the volute module is used as part of a single-stage centrifugal pump or a multi-stage centrifugal pump, the same volute is used to convert the rotation of the last or final impeller in the impeller chamber which is always the unencapsulated impeller. In case the volute module is used as part of a single-stage centrifugal pump, the final or last impeller is also the first or initial impeller that is arranged in the volute module.

In case the volute module is used as part of a multi-stage centrifugal pump, an initial-stage impeller housing is placed in the impeller chamber. That initial-stage impeller housing surrounds a first impeller which receives the incoming flow of pump fluid from the outside of the pump. This impeller, which may also be referred to as an initial-stage impeller, is also rotatable about the drive axis and sets the pump fluid into rotation to generate pressure. The initial-stage impeller housing further comprises so-called guide vanes which are provided for converting the rotating flow of the initial-stage impeller to a linear flow that flows in a direction parallel to the drive axis towards the subsequent stage of the multi-stage pump, i.e., away from the bottom wall of the impeller chamber.

Depending on the number of stages of the multi-stage centrifugal pumps, the subsequent stage of the pump may be formed by the unencapsulated impeller or by an intermediate-stage impeller housing. In case the subsequent state of the initial-stage impeller housing is formed by the unencapsulated impeller, the multi-stage centrifugal pump is a double-stage pump. Otherwise, one or more intermediate-stage impeller housings may be placed on top of each other to form a multi-stage centrifugal pump with more than two pump stages. The number of pump stages corresponds to the number of impellers placed in the impeller chamber. Each of the intermediate-stage impeller housings encapsulates an impeller which is rotatable about the drive axis and also includes guide vanes that guide the rotating flow created by the respective impeller placed inside that intermediate-stage impeller housing towards the subsequent stage of the multi-stage centrifugal pump. Note that in particular in this case the outer walls of the impeller chamber are not necessarily formed entirely by the body of the volute module.

In summary, the volute module can be used both for single-stage and multi-stage centrifugal pumps. To this end, the impeller chamber formed by the volute module and, in particular, the body of the volute module are configured so that for use as a part of a single stage centrifugal pump, only an unencapsulated impeller is installed in the impeller chamber, whereas for use as multi-stage centrifugal pump, at least an initial stage impeller housing and potentially one or more additional intermediate stage impeller housings can be installed in the impeller chamber in addition to the unencapsulated impeller.

In any configuration the volute module comprises an unencapsulated impeller which is arranged in the impeller chamber. When the volute module is used as part of a single-stage centrifugal pump, it only comprises the unencapsulated impeller and no initial-stage impeller housing. Nevertheless, the impeller chamber is designed to not only include the unencapsulated impeller but can also receive at least an initial-stage impeller housing and potentially also further intermediate-stage impeller housings. This advantageously increases the efficiency by eliminating the last impeller housing in the multistage setup. Also, a pump without a last impeller housing requires less height along the drive axis enabling a more compact design. Further, the number of parts required for providing a large number of single-stage and multi-stage pumps is reduced which simplifies production of the pumps.

In a preferred embodiment, the volute is delimited in the direction of the drive axis by an upper edge and a lower edge. The unencapsulated impeller comprises a lower base plate an upper base plate and at least one impeller blade arranged between the upper base plate and the lower base plate. The upper base plate and the lower base plate may, for example, extend parallel to each other and perpendicular to the drive axis but can also have deviating forms. A distance between an outer edge of the upper base plate and an outer edge of the lower base plate is less than a distance between the lower edge of the volute and an upper edge of the volute in the direction of the drive axis.

In other words, in the preferred embodiment a height of the unencapsulated impeller in the direction of the drive axis is less than the height of the volute in the direction of the drive axis. Here, the height of the unencapsulated impeller would be defined as the distance between the outer edge of the upper base plate and the outer edge of the lower base plate of the impeller.

Similarly, the height of the volute is defined by the distance between an upper edge and a lower edge of the volute towards the impeller chamber. Preferably, the upper edge extends in a plane which is parallel to a plan in which the lower edge extends. Even more preferably, the upper edge and the lower edge extend in planes which are perpendicular to the drive axis. In case the upper and lower edges of the volutes should not extend in parallel planes, the height of the impeller should, for example, be less than a minimum distance between the upper edge and the lower edge of the volute.

In an exemplary preferred embodiment, the distance between the outer edge of the upper base plate and the outer edge of the lower base plate is preferably 70% or less more preferably 50% or less than the distance between lower edge of the volute and the upper edge of the volute.

In a preferred embodiment in which the volute is delimited in the direction of the drive axis by an upper edge and a lower edge, a circumference of the upper edge of the volute is greater than a circumference of the lower edge of the volute. Hence, in the preferred embodiment the impeller chamber is wider at the upper edge of the volute than at the lower edge of the volute.

When the upper edge and the lower edge extend in parallel planes, the cross-sectional area of the impeller chamber delimited by the lower edge of the volute is smaller than the cross-sectional area of the impeller chamber delimited by the upper edge of the volute. Thereby, the flow of the pump fluid is facilitated in case the volute module is used as part of a multi-stage centrifugal pump and at least an initial-stage impeller chamber is placed in the impeller chamber. At the same time, at the lower edge, the volute is moved as closely as possible towards the drive axis so that the distance that the flow accelerated by the unencapsulated impeller has to travel is minimized before it is collected by the volute when the volute module is used as part of a single-stage pump.

In an exemplary preferred embodiment, the upper edge of the volute and the lower edge of the volute are both circular and a radius of the circular upper edge is greater than a radius of the circular lower edge. The advantages of this configuration correspond to that of the preceding embodiment.

In a further preferred embodiment, the lower edge of the volute delimits a bottom wall of the impeller chamber. The bottom wall surrounds an inlet opening for the pump fluid.

Thus, in the preferred embodiment the lower edge of the volute at the same time forms an outer edge of the bottom wall of the impeller chamber. The bottom wall includes a preferably central and circular inlet opening through which pump fluid is sucked by the first impeller of the volute module into the impeller chamber. That first impeller may, for example, be the unencapsulated impeller when the volute module is used as a part of a single-stage centrifugal pump or the impeller of an initial-stage impeller housing in case the volute module is used as part of a multi-stage centrifugal pump.

Preferably, the bottom wall generally extends perpendicular to the drive axis and a center of the inlet opening is further preferably aligned with drive axis.

It is generally preferred that the pump housing is configured such that pump fluid is only drawn into the impeller chamber by the impeller of the initial stage impeller housing when the volute module is used as part of a multi-stage centrifugal pump and such that pump fluid is drawn into the impeller chamber by the unencapsulated impeller when the volute module is used as part of a single-stage centrifugal pump.

In a preferred embodiment, a distance of an inner surface of the volute facing towards the impeller chamber from the drive axis increases in a plane extending perpendicular to the drive axis from an entry region of the volute until the volute transitions into the pressure outlet of the volute module. A tongue of the volute separating the entry region of the volute from the pressure outlet of the volute module is tilted away from the drive axis when viewed from the lower edge of the volute to the upper edge of the volute.

Hence, in the preferred embodiment, a depth of the volute measured in a plane extending perpendicular to the drive axis increases from the tongue of the volute to the region where the volute transitions into the pressure outlet of the volute module. Thereby, the rotating flow created by the unencapsulated impeller is directed towards the pressure outlet.

In a further preferred embodiment, the volute module is configured such that when the volute module is used as part of a multi-stage centrifugal pump, a rotating flow of a pump fluid created by the unencapsulated impeller flows away from the unencapsulated impeller towards an outer wall of the impeller chamber where it is directed towards the volute.

Hence, in the preferred embodiment the volute module comprises an outer wall which directs or guides the flow created by the final stage of the multi-stage pump towards the volute and, thus, the pressure outlet of the volute module. The outer wall may also be formed by the body of the volute module. However, it is preferred that a section of the outer wall that redirects the flow of the unencapsulated impeller of a multi-stage centrifugal pump is formed by an additional sleeve that is placed on the body to extend the outer wall and increase the size of the impeller chamber to accommodate additional pump stages. Using a sleeve for providing the outer wall has the advantage that different sized sleeves can be used to adapt the outer wall to multi-stage centrifugal pumps with different number of stages. For example, for each number of stages one specific sleeve could be provided.

In a preferred embodiment the volute module comprises a chamber support. An inner surface of the chamber support facing towards the drive axis partially surrounds the impeller chamber. The chamber support is configured for directing the rotating flow of pump fluid generated by the unencapsulated impeller towards the volute.

Thus, in the preferred embodiment a chamber support is provided which serves as an upper end of the impeller chamber, i.e., it delimits the impeller chamber on a side facing away from the bottom wall of the impeller chamber. This chamber support could, for example, also serve for supporting the volute module on a motor mount or motor stool that is also part of the multi-stage centrifugal pump or attaching it thereto.

Also, when the volute module is used as part of a multi-stage centrifugal pump, the chamber support may be provided for holding the last impeller housing in the impeller chamber in place in a plane extending perpendicular to the drive axis and can further be used to exert a force onto a sleeve and any impeller housing inside the impeller chamber towards the body of the volute module. The force or load acting on the sleeve and the one or more impeller housings can, for example, be created using stay bolts which are used to attach the motor mount to the volute module.

The inner surface of this chamber support further serves as a guide surface that directs the rotating flow generated by the unencapsulated impeller towards the volute. As previously mentioned, the unencapsulated impeller does not comprise a housing and the flow is primarily guided by the inner surface of the body of the volute module and an inner surface of the chamber support towards the volute.

When the volute module is used as part of a multi-stage, the volute module is preferably further configured such that the rotating flow of pump fluid generated by the unencapsulated impeller is directed by the chamber support to flow between an outer surface of the initial stage impeller housing and an inner surface of the impeller chamber towards the volute. Thus, when the volute module is used as part of a multi-stage pump, the flow is further be guided by outer surfaces of any impeller housings placed in the impeller chamber as well as an inner surface of the outer wall of the impeller chamber. That outer wall may, for example, be formed by a sleeve.

In a preferred embodiment the volute module comprises at least one end guide vane for redirecting the rotating flow of a pump fluid created by the unencapsulated impeller towards the volute. The at least end guide vane is preferably part of the chamber support. Further, the at least one end guide vane has in an exemplary preferred embodiment also a structural function as the at least one end guide vane can be used to transfer a load exerted by stay bolts mounting the motor stool to the base of the volute module onto the one or more internal impeller housings. This keeps the impeller housings in place.

Preferably, the chamber support comprises between 3 and 7 end guide vanes and even more preferably 4 end guide vanes.

Hence, in the preferred embodiment at least one dedicated end guide vane is provided which improves the flow of the rotating pump fluid accelerated by the unencapsulated impeller towards the volute. The one or more end guide vanes support the flow of the pump fluid away from the drive axis. They may also aid in changing the direction of the flow towards a direction parallel to the drive axis. Also, the guide vanes may preferably direct the pump fluid away from the unencapsulated impeller and a top wall of the impeller housing formed by the chamber support towards the volute and the bottom wall of the body of the volute module.

In an exemplary embodiment where the volute module is used as part of a multi-stage pump, the flow would be redirected towards that region of the impeller chamber in which the initial-stage impeller chamber is arranged. The end guide vanes thus direct the rotating flow created by the unencapsulated impeller in the opposite direction than the guide vanes of the initial stage impeller housing and any intermediate stage impeller housings: away from the drive axis, and also towards the bottom wall and the volute of the volute module.

In a preferred embodiment the end guide vane is formed on the chamber support which delimits the impeller chamber towards the motor stool. The motor stool may, for example, be attached to the body of the volute module via stay bolts and the chamber support would thus be configured to transfer loads created by the stay bolts onto the sleeve and the internal impeller housings arranged in the impeller chamber to keep them in place and enable a tight connection between the components of the pump housing. The guide vanes formed on the chamber support could in this case also be configured to transfer these loads from the motor stool onto the one or more impeller housings.

In a second aspect the problem underlying the present invention is solved by a single-stage centrifugal pump comprising a volute module according to any of the preceding embodiments and a motor housing attached to the volute module. The volute module comprises the unencapsulated impeller but no initial-stage impeller housing and not intermediate-stage impeller housing. The advantages and specific embodiments of the single-stage centrifugal pump correspond to the embodiments of the volute module used as part of the single-stage centrifugal pump.

The volute module in this embodiment is part of a single-stage centrifugal pump. However, since at least the body of the volute module defining the volute and part of the impeller chamber allows placing an initial-stage impeller housing and one or more intermediate-stage impeller housings therein, the volute module can be identified as a volute module that can is also suitable for a multi-stage centrifugal pump.

In another aspect the problem underlying the present invention is solved by a multi-stage centrifugal pump comprising an embodiment of a volute module as previously described as well as a motor housing. The volute module comprises the unencapsulated impeller and the initial-stage impeller housing.

In an exemplary preferred embodiment of the multi-stage centrifugal pump the volute module further comprises one or more intermediate-stage impeller housings. Each intermediate-stage impeller housing encapsulates an impeller rotatable about the drive axis and comprises guide vanes directing a flow of a pump fluid from the impeller of the respective intermediate-stage impeller housing towards an impeller of a subsequent stage of the multi-stage centrifugal pump. The subsequent stage of the multi-stage centrifugal pump is formed by the unencapsulated impeller or by another intermediate-stage impeller housing.

The advantages of the multi-stage centrifugal pump correspond to those of the embodiment of the volute module used therein. It should be noted that in any case that at least the body of the volute module as well as the unencapsulated impeller of the multi-stage centrifugal pump can also be used for a single-stage centrifugal pump.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

While specific embodiments of the invention have been shown and described in detail to illustrate the application of the principles of the invention, it will be understood that the invention may be embodied otherwise without departing from such principles.

### BRIEF DESCRIPTION OF THE DRAWINGS

In the drawings:

FIG. 1 is a partial sectional view of an exemplary embodiment of a volute module used as part of a single-stage centrifugal pump;

FIG. 2 is an isometric sectional view of the embodiment of FIG. 1;

FIG. 3 is a partial sectional view of the exemplary embodiment of a volute module shown in FIG. 1 used as part of a multi-stage centrifugal pump; and

FIG. 4 is a sectional view of the embodiment of FIG. 4.

### DESCRIPTION OF PREFERRED EMBODIMENTS

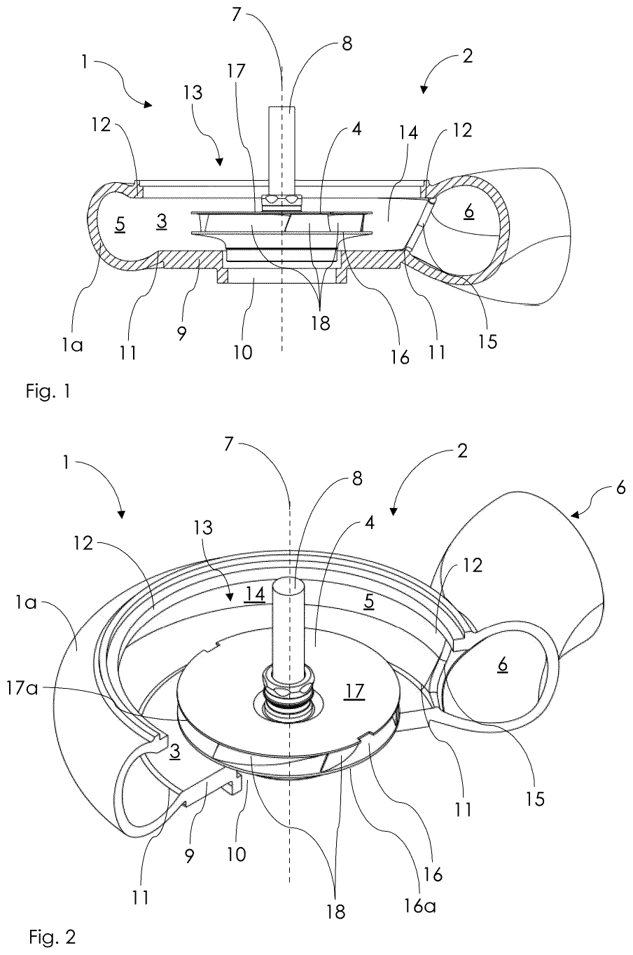

Referring to the drawings, FIGS. 1 and 2 show an exemplary embodiment of a volute module 1 comprised in a single-stage centrifugal pump 2. The volute module 1 comprises a body 1a defining an impeller chamber 3 in which an unencapsulated impeller 4 is arranged. The body 1a of the volute module 3 further defines a volute 5 which surrounds the impeller chamber 3 and terminates into a pressure outlet 6 of the volute module 1. The body 1a of the volute module 1 defining part of the impeller chamber 3, the volute 5 and also the pressure outlet 6 is made from a single piece which has been manufactured using conventional casting processes, plastic injection molding, 3D printing or other suitable processes. The body 1a can, for example, be made from cast iron, stainless steel, titanium, plastic or any other material suitable for the application.

The unencapsulated impeller 4 is rotatable about a drive axis 7 and driven by means of a drive shaft 8 which can be connected to an electric motor not shown in the Figures. Note that the unencapsulated impeller 4 is shown in full in FIGS. 1 and 2 and not as a sectional drawing.

A lower end of the volute module 1 is formed by a bottom wall 9 which surrounds an inlet opening 10 through which pump fluid is sucked into or ingested into the impeller chamber 3 by a rotation of the unencapsulated impeller 4. The bottom wall 9 is also part of the body 1a of the volute module 1 and thus formed in one piece with the walls partially surrounding the impeller chamber 3 and defining the volute 5.

An outer perimeter of the bottom wall 9 is formed by the circular lower edge 11 of the volute 5. The bottom wall 9 forms a lower end of the impeller chamber 3 as it is furthest away from a motor driving the unencapsulated impeller 4. The volute 5 is further delimited by an upper edge 12 which forms, in the embodiment shown in FIGS. 1 and 2, also an upper end of the impeller chamber 3. The upper edge 12 is also circular.

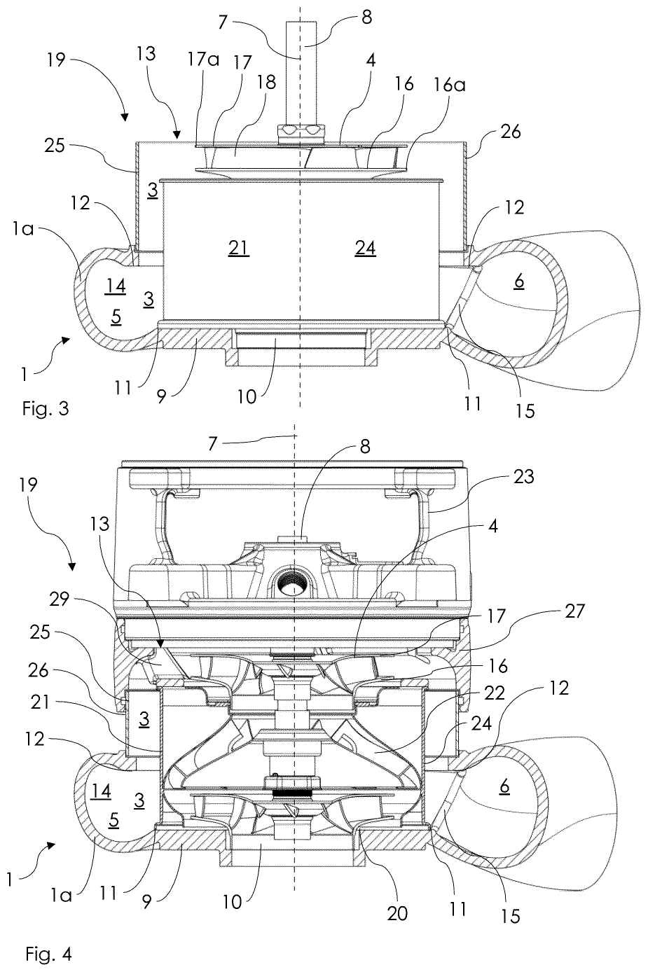

As can be seen in FIG. 1, the circumference of the upper edge 12 of the volute 5 is greater than the circumference of the lower edge 11 of the volute. In other words, the impeller chamber 3 is wider in a plane extending perpendicular to the drive axis 7 at the upper edge 12 of the volute 5 than at the lower edge 11. As will be discussed with regard to FIGS. 3 and 4, this design of the impeller chamber 3 and the volute 5 allows using the body 1a of the volute module 1 also for a multi-stage centrifugal pump.

The width of the impeller chamber 3 in a plane perpendicular to the drive axis 7 can also be expressed in terms of a radius of the circular lower and upper edge 11, 12 of the volute 5. The radius of the lower edge 11 about the drive axis 7 is thus smaller than the radius of the upper edge 12 of the volute 5.

The volute 5 is provided for directing the circulating flow of pump fluid created by the unencapsulated impeller 4 towards the pressure outlet 6 of the volute module 1. To this end, an inner surface 14 of the body 1a defining the volute 5 is formed so that in a plane extending perpendicular to the drive axis 7, a distance of the inner surface 14 facing towards the drive axis 7 increases from the tongue 15 of the volute 5 to a region where the volute 5 transitions into the pressure outlet 6. The latter region is not shown in the figures whereas the tongue 15 is defined as the part of the body 1a of the volute module 1 separating an entry region of the volute 5 which is closest to the drive axis 7 from the pressure outlet 6.

It should be noted that the distance of the inner surface 14 from the drive axis depends on the plane extending perpendicular to the drive axis 7 at which the distance from the drive axis 7 is established. Thus, as can further be seen in FIGS. 1 and 2, the volute 5 may comprise inner surfaces 14 which face away from the drive axis 7. In planes which comprise both surfaces facing away from the drive axis 7 and towards the drive axis 7, the increase of the distance from the drive axis 7 starting from the tongue 15 to the region where the volute 5 merges into the pressure outlet 6 increases at least for those surfaces which face towards the drive axis 7.

As can further be seen in FIG. 1, when projected onto a plane extending parallel to or through the drive axis 7, the tongue 15 is tilted away from the drive axis 7 in the direction from the lower edge 11 to the upper edge 12 of the volute 5. This tilt also accommodates the increase of the width of the impeller chamber 3 in a direction away from the bottom wall 9. As will be explained in detail later with regard to FIGS. 3 and 4, this increase in the width of the impeller chamber 3 allows using the body 1a of the volute module 1 shown in FIG. 2 also for multi-stage centrifugal pumps.

The unencapsulated impeller 3 comprises a lower base plate 16 and an upper base plate 17 between which a plurality of impeller vanes 18 are arranged. As can be seen best in FIG. 1, a distance between an outer edge 16a of the lower base plate 16 and an outer edge 17a of the upper base plate 17 of the impeller is about 50% of the distance between the lower edge 11 and the upper edge 12 of the volute 5 in the direction of the drive axis 7. The difference in height serves to improve the flow of the pump fluid in case the body 1a is used as part of a volute module 1 for a multi-stage centrifugal pump.

FIGS. 3 and 4 show an exemplary embodiment of a volute module 1 as part of a multi-stage centrifugal pump 19. The multi-stage centrifugal pump 19 shown in FIGS. 3 and 4 is based on the exemplary embodiment of a volute module 1 as shown in FIGS. 1 and 2 and, in particular, used the same exemplary embodiment of a body 1a and the same unencapsulated impeller 4.

For the sake of brevity, only those elements of the volute module 1, which have not been discussed in more detail with regard to FIGS. 1 and 2, will be discussed with regard to FIGS. 3 and 4. Otherwise, reference is made to the description of the preceding figures.

The multi-stage centrifugal pump 19 comprises two stages, i.e., two impellers 4, 20. In FIG. 3 only the unencapsulated impeller 4 which is the same impeller 4 as the unencapsulated impeller 4 shown in FIGS. 1 and 2 is visible.

The second impeller 20, which may also be referred to as an initial-stage impeller 20, is provided inside an initial-stage impeller housing 21 which is placed inside the impeller chamber 3. The initial-stage impeller 20 is rotatable about the drive axis 7 and also driven by means of the drive shaft 8. The drive shaft 8 may be provided in multiple parts as can be seen in FIG. 4 further adding to the modularity of the pump housing 2, 19.

Pump fluid flows through the inlet opening 10 into the initial impeller housing 21, where it is energized by the initial-stage impeller 20. As can be seen in FIG. 4, the initial impeller housing 21 comprises or defines guide vanes 22 which redirect the circulating flow of a pump fluid created by the initial-stage impeller 20 towards the drive axis 7 and upwards towards the subsequent stage of the multi-stage centrifugal pump 19. Here upwards refers to the direction away from the bottom wall 9 of the volute module 1 and towards the motor mount or chamber support 23.

The guide vanes 22 thus transform the rotation of the pump fluid into pressure which is then received by the unencapsulated impeller 4 which shows the second and thus final stage of the multi-stage centrifugal pump 19.

As can be seen in the cross-sectional depiction in FIG. 4, the upper and lower base plate 16, 17 of the initial stage impeller 20 and the unencapsulated impeller 4 are not plane but rather have a complex shape. As previously discussed, the height of the impeller 4 in the direction of drive axis 7 is defined by a distance between the outer edges 16a, 17a upper base plate and the lower base plate 16, 17 wherefore the height previously defined can be determined for these impellers 4, 20.

The unencapsulated impeller 4 is also driven by the drive shaft 8 and sets the pump fluid received from the initial-stage impeller 20 into rotation. The rotating flow is then guided between an outer surface 24 of the initial-stage impeller housing 21 and an inner surface 25 of the impeller chamber 3 towards the volute 5 and thus the pressure outlet 6 of the volute module 1. The inner surface 25 of the impeller chamber 3 is partially formed by a sleeve 26 which is used to increase the size of the impeller chamber 3 for a multi-stage centrifugal pump 19 from the single-stage centrifugal pump 2 shown in FIG. 1.

In case the multi-stage centrifugal pump 19 shall have more than two stages, a different sleeve 26 with a longer extension in the direction of the drive axis 7 will be used. Thereby, the impeller chamber 3 can be easily adapted to a different number of pump stages without requiring a different body 1a of the volute module 1 and a different unencapsulated impeller 4. Thereby, the number of parts required is reduced and the production of the pumps is simplified.

As can only be seen in FIG. 4, the volute module 1 further comprises a chamber support 27 on which the motor mount or motor stool 23 is arranged. Thus, the chamber support 27 delimits the impeller chamber 3 towards the motor mount 23. Further, the chamber support exerts a load onto the sleeve 26 and the initial-stage impeller housing 21 towards the body 1a of the volute module 1 to keep the sleeve 26 and the impeller housing 21 in place and hold them tightly against the body 1a. The load may, for example, be created using stay bolts (not shown) that are used to secure the motor mount 23 on the body 1a of the volute module 1. The motor mount 23 is provided for connecting the volute module 1 to a motor or drive means (not shown).

Further, the chamber support 27 defines one or more end guide vanes 29 which redirect the circulating flow created by the unencapsulated impeller 4 towards a gap extending between the outer surface 24 of the initial-stage impeller housing 21 and an inner surface 25 of the sleeve 26 and further towards the volute 5 and the pressure outlet 6. The end guide vanes 29 are also part of the load transferring structure which is used to transfer the load generated by the motor stool 23 onto the initial-stage impeller housing 21 and the sleeve 26.

In FIG. 4 only one of the end guide vanes 29 has been designated with a reference numeral to keep the figure intelligible. The end guide vanes 29 are primarily provided for redirecting the rotating flow in the direction away from the second end 13 of the impeller chamber 3 and thus towards the bottom wall 9 of the volute module 1.

Hence, in the exemplary embodiment of a multi-stage centrifugal pump 19 shown in FIGS. 3 and 4 the rotating flow created by the last or final impeller of the pump stages (which is formed by the unencapsulated impeller 4) directly flows towards the volute 5 and thus the pressure outlet 6. In existing multi-stage centrifugal pumps, additional guide vanes similar to those guide vanes 22 in the initial-stage impeller housing 21 are provided which redirect the rotating flow of the last impeller towards the drive axis 7 and convert the rotation of the flow into pressure. The resulting linear flow thus flows along the shaft 8, i.e., in the direction of the drive axis 7 towards the second end 13 of the impeller chamber 3. Here, the direction of the flow is turned towards the pressure outlet 6 of the conventional multi-stage centrifugal pump. Comparted to this conventional setup, the efficiency of the present embodiment is improved as the rotating flow is aimed directly at the volute 5 and the pressure outlet 6. Further, the overall height of the multi-stage centrifugal pump 19 is reduced since the impeller chamber 3 does not have to accommodate an impeller housing for the final-stage impeller 4 resulting in an overall more compact design.

### List of Reference Numerals

1 volute module
1a body of the volute module
2 single-stage centrifugal pump
3 impeller chamber
4 unencapsulated impeller
5 volute
6 pressure outlet
7 drive axis
8 drive shaft
9 bottom wall
10 inlet opening
11 lower edge of the volute
12 upper edge of the volute
13 upper end of the impeller chamber
14 inner surface of the volute
15 tongue
16 lower base plate of the unencapsulated impeller
16a outer edge of the lower base plate
17 upper base plate of the unencapsulated impeller
17a outer edge of the lower base plate
18 impeller vanes
19 multi-stage centrifugal pump
20 initial-stage impeller or second impeller
21 initial-stage impeller housing
22 guide vanes in initial-stage impeller housing
23 motor mount/motor stool
24 outer surface of the initial stage impeller housing
25 inner wall of the sleeve
26 sleeve
27 chamber support
29 end guide vane

1. A volute module for a single-stage centrifugal pump and a multi-stage centrifugal pump, wherein the volute module comprises:
a body defining at least part of an impeller chamber as well as a volute at least partially surrounding the impeller chamber;
an unencapsulated impeller rotatable about a drive axis in the impeller chamber wherein the volute module is configured such that a rotating flow of pump fluid created by the unencapsulated impeller is directed towards the volute which channels the rotating flow of pump fluid towards a pressure outlet of the volute module; and
an initial-stage impeller housing in the impeller chamber, configured for when the pump housing is used as part of a multi-stage centrifugal pump, wherein the initial-stage impeller housing encapsulates another impeller rotatable about the drive axis and defines guide vanes directing a flow of a pump fluid from the impeller of the initial-stage impeller housing towards a subsequent stage impeller of a subsequent stage of the multi-stage centrifugal pump, wherein the subsequent stage impeller is formed by the unencapsulated impeller or by a further intermediate-stage impeller housing which encapsulates a further impeller rotatable about the drive axis and defines guides vanes.

2. The volute module according to claim 1, wherein the volute is delimited in the direction of the drive axis by an upper edge and a lower edge, wherein the unencapsulated impeller comprises a lower base plate, an upper base plate and at least one impeller vane arranged between the upper base plate and the lower base plate and wherein a distance between an outer edge of the upper base plate and an outer edge of the lower base plate is less than a distance between the lower edge of the volute and the upper edge of the volute in the direction of the drive axis.

3. The volute module according to claim 1, wherein the volute is delimited in the direction of the drive axis by an upper edge and a lower edge, and wherein a circumference of the upper edge of the volute is greater than a circumference of the lower edge of the volute.

4. The volute module according to claim 2, wherein the lower edge delimits a bottom wall of the impeller chamber, wherein the bottom wall surrounds an inlet opening for the pump fluid.

5. The volute module according to claim 2, wherein in a plane extending perpendicular to the drive axis, a distance of an inner surface of the volute facing towards the impeller chamber from the drive axis increases from an entry region of the volute until the volute transitions into the pressure outlet of the volute module, wherein a tongue of the volute separating the entry region of the volute from the pressure outlet of the volute module is tilted away from the drive axis when viewed from the lower edge of the volute to the upper edge of the volute.

6. The volute module according to any of the preceding claim 1, wherein the volute module is configured such that when the volute module is used as part of a multi-stage centrifugal pump, a rotating flow of a pump fluid created by the unencapsulated impeller flows away from the unencapsulated impeller towards an inner surface of the impeller chamber where the rotating flow is directed towards the volute.

7. The volute module according to claim 1, wherein the volute module comprises a chamber support, wherein an inner surface of the impeller chamber facing towards the drive axis partially surrounds the impeller chamber and wherein the chamber support is configured for directing the rotating flow of pump fluid generated by the unencapsulated impeller towards the volute.

8. The volute module according to claim 7, wherein when the volute module is used as part of a multi-stage centrifugal pump, the volute module is configured such that the rotating flow of pump fluid generated by the unencapsulated impeller is directed by the chamber support to flow between an outer surface of the initial-stage impeller housing and the inner surface of the impeller chamber towards the volute.

9. The volute module according to claim 7, wherein the chamber support comprises at least one end guide vane for direction the rotating flow of pump fluid generated by the unencapsulated impeller towards the volute.

10. The volute module according to claim 1, wherein the volute module comprises at least one end guide vane for redirecting the rotating flow of pump fluid created by the unencapsulated impeller towards the volute

11. The volute module according to claim 7, wherein the at least one end guide vane is part of the chamber support.

12. A single-stage centrifugal pump comprising a volute module further comprising a body defining at least part of an impeller chamber as well as a volute at least partially surrounding the impeller chamber; an unencapsulated impeller rotatable about a drive axis in the impeller chamber, wherein the volute module is configured such that a rotating flow of pump fluid created by the unencapsulated impeller is directed towards the volute which channels the rotating flow of pump fluid towards a pressure outlet of the volute module; and an initial-stage impeller housing in the impeller chamber, configured for when the pump housing is used as part of a multi-stage centrifugal pump, wherein the initial-stage impeller housing encapsulates another impeller rotatable about the drive axis and defines guide vanes directing a flow of a pump fluid from the impeller of the initial-stage impeller housing towards a subsequent stage impeller of a subsequent stage of the multi-stage centrifugal pump, wherein the subsequent stage impeller is formed by the unencapsulated impeller or by a further intermediate-stage impeller housing which encapsulates a further impeller rotatable about the drive axis and defines guides vanes; and
a motor housing attached to the volute module, wherein the volute module comprises the unencapsulated impeller but no initial-stage impeller housing and no intermediate stage impeller housing.

13. A multi-stage centrifugal pump comprising;
a volute module further comprising a body defining at least part of an impeller chamber as well as a volute at least partially surrounding the impeller chamber; an unencapsulated impeller rotatable about a drive axis in the impeller chamber, wherein the volute module is configured such that a rotating flow of pump fluid created by the unencapsulated impeller is directed towards the volute which channels the rotating flow of pump fluid towards a pressure outlet of the volute module; and an initial-stage impeller housing in the impeller chamber, configured for when the pump housing is used as part of a multi-stage centrifugal pump, wherein the initial-stage impeller housing encapsulates another impeller rotatable about the drive axis and defines guide vanes directing a flow of a pump fluid from the impeller of the initial-stage impeller housing towards a subsequent stage impeller of a subsequent stage of the multi-stage centrifugal pump, wherein the subsequent stage impeller is formed by the unencapsulated impeller or by a further intermediate-stage impeller housing which encapsulates a further impeller rotatable about the drive axis and defines guides vanes; and
a motor housing, wherein the volute module comprises the unencapsulated impeller and the initial-stage impeller housing, wherein the volute module further comprises one or more intermediate stage impeller housings, wherein each inter-mediate-stage impeller housing encapsulates an impeller rotatable about the drive axis and comprises guide vanes directing a flow of a pump fluid from the impeller of the respective intermediate-stage impeller housing towards an impeller of a sub-sequent stage of the multi-stage pump, wherein the subsequent stage of the multi-stage is formed by the unencapsulated impeller or by another intermediate-stage impeller housing.
